(19) United States
(12) Patent Application Publication
(10) Pub. No.: US 2026/0089237 A1
(43) Pub. Date: Mar. 26, 2026

(54) CONTEXT-AWARE, DOMAIN-SPECIFIC AI SYSTEM IMPLEMENTED IN A LOCATION-BASED PEER-TO-PEER COMMUNICATION PLATFORM

(71) Applicant: CELLIGENCE INTERNATIONAL LLC, Guaynabo, PR (US)

(72) Inventors: Pavan AGARWAL, DORADO, PR (US); Gabriel Albors SANCHEZ, SAN JUAN, PR (US); Jonathan Ortiz RIVERA, SAN JUAN, PR (US); Dennis J. BORRERO, SAN JUAN, PR (US); Arindam BRAHMA, ALISO VIEJO, CA (US)

(73) Assignee: CELLIGENCE INTERNATIONAL LLC, Guaynabo, PR (US)

(21) Appl. No.: 19/339,066

(22) Filed: Sep. 24, 2025

Related U.S. Application Data
(60) Provisional application No. 63/699,677, filed on Sep. 26, 2024.

(51) Int. Cl. H04L 67/60; G06F 40/35; G06F 40/40

(52) U.S. Cl. CPC H04L 67/60; G06F 40/35; G06F 40/40

(57) ABSTRACT

A system is disclosed that integrates a context-aware, domain-specific artificial intelligence architecture into a location-based or interest-based peer-to-peer communication platform. The system improves operation of such platforms by enabling streamlined content discovery, enhanced personalization, efficient user and group administration, and dynamic content and user moderation with minimal computational requirements. Technical improvements include leveraging a pre-trained language model in conjunction with a procedural function framework, semantic search, and content retrieval modules to generate context-aware responses without resource-intensive retraining. The architecture supports classification, parameter extraction, and sentiment analysis to provide accurate and scalable query handling while reducing latency and computational load.

### RELATED APPLICATIONS

This application claims the benefit of U.S. Provisional Application No. 63/699,677 filed on Sep. 26, 2024, the entirety of which is incorporated herein by reference.

### BACKGROUND

In conventional communication platforms, users are often provided with the ability to create location-based or interest-based chat groups. These platforms typically allow users to engage in discussions with others who share the same geographic area or interest (e.g., a neighborhood, a particular hobby, or a professional group). However, these platforms have limitations in their functionality and scalability when it comes to managing complex interactions and obtaining user-specific content including personalized responses to requests.

The disclosed system overcomes these limitations by incorporating a context-aware, domain-specific AI architecture into a location-based or interest-based communication platform, enhancing user experience, streamlining content discovery, improving personalization, and providing dynamic content moderation with minimal computational requirements.

### FIELD OF INVENTION

The present disclosure relates generally to artificial intelligence and communication technologies, and more particularly to systems and methods for integrating context-aware, domain-specific artificial intelligence into location-based or interest-based peer-to-peer communication platforms. The disclosed embodiments encompass technical improvements in natural language processing, sentiment analysis, procedural function orchestration, and dynamic content retrieval, with applications in community forums, event coordination, moderation, personalization, and security.

### SUMMARY

In accordance with one or more embodiments, the disclosed system comprises a peer-to-peer location-based communication platform that leverages a context-aware, domain-specific AI architecture resulting in an enhanced user experience and technical improvements such as streamlined content discovery, improved personalization, efficient user and group administration, and dynamic content and user moderation with minimal computational requirements.

The AI architecture utilizes a pre-trained large language model (LLM) or other machine learning model in conjunction with a procedural function management framework, semantic search engine, and content retrieval modules. For example, the system provides accurate, context-aware responses to requests without requiring the extensive retraining typically associated with domain-specific applications of LLMs. or other machine learning models. The requests may include specific-user-content-based requests (i.e., requests based on data directly or indirectly generated by a specific user of the platform such as a neighbor looking for chat groups) and non-specific-user-content based requests (e.g., requests generated by the system in response to data by any user, e.g., harmful user content evaluation for moderation purposes). The system achieves this by dynamically constructing and executing functions and prompts, enabling efficient use of computing resources while maintaining scalability and adaptability to new tasks and data.

Various features and functionality can be provided for context-aware, domain-specific query response and sentiment analysis system. The system includes a chat interface for receiving user requests, a request endpoint application programming interface (“API”) configured to handle response tasks; a sentiment predictor endpoint application programming interface (“API”) for handling user sentiment; and a pre-trained LLM (PT-LLM) configured to operate in multiple modalities and/or ecosystems. The conversation engine includes a classification model for determining user's intent or action, an extraction model for extracting parameters or entities associated with user's intent or action, and a procedural function engine for dynamically generating and managing procedural functions based on the extracted parameters. The procedural functions include sentiment prediction and response generation (e.g., via a sentiment prediction engine); coordinating content retrieval and LLM activation (e.g., via a chat orchestrator engine), retrieving content (e.g., via an augmenting content retriever (ACR) accessing an augmenting content store (ACS)); and constructing prompts for the LLM (e.g., via a dynamic augmented prompt builder (DAPB)).

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1A depicts a network including a location-based or interest-based communication platform powered by a conversation engine with a flexible and dynamic Al architecture, according to an implementation of the disclosure.

FIG. 1B illustrates an exemplary schematic diagram of a computer-based architecture of a procedural function framework of the conversation engine in FIG. 1A in greater detail, according to an implementation of the disclosure.

FIG. 1C illustrates an exemplary schematic diagram of a computer-based architecture of a communication platform engine of the location-based or interest-based communication platform in FIG. 1A in greater detail, according to an implementation of the disclosure.

FIG. 2 illustrates an exemplary process of the conversation engine for responding to requests of FIG. 1A, according to an implementation of the disclosure.

FIG. 3 illustrates an example computing system that may be used in implementing various features of embodiments of the disclosed technology.

Described herein are systems and methods for context-aware, domain-specific query answering and sentiment analysis. The details of some example embodiments of the systems and methods of the present disclosure are set forth in the description below. Other features, objects, and advantages of the disclosure will be apparent to one of skill in the art upon examination of the following description, drawings, examples and claims. It is intended that all such additional systems, methods, features, and advantages be included within this description, be within the scope of the present disclosure, and be protected by the accompanying claims.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description in order to provide a thorough understanding of the embodiments disclosed herein, some embodiments can be practiced without some of these details. Moreover, for the purpose of clarity, certain technical material that is understood in the related art has not been described in detail in order to avoid unnecessarily obscuring the disclosure. Furthermore, the disclosure, as illustrated and described herein, may be practiced in the absence of an element that is not specifically disclosed herein.

### CONVENTIONAL SYSTEM LIMITATIONS

Conventional peer-to-peer or location-based communication platforms are generally limited in several respects. First, moderation and trust mechanisms typically rely on manual review or simple keyword filters, which are error-prone, slow, and ill-suited to real-time group interactions. Second, personalization features are often rule-based (e.g., “users in ZIP code 92130 see local vendors”) and cannot adapt dynamically to evolving user intent. Third, conventional natural language processing (NLP) modules are computationally heavy, often requiring repeated training on domain-specific datasets whenever new categories of user requests or new community guidelines are introduced. This retraining imposes high GPU and cloud costs and introduces significant latency into deployment cycles. Finally, prior platforms generally lack the ability to coordinate asynchronous and synchronous task execution across distributed modules, resulting in inefficiencies such as dropped requests, redundant data pulls, or inconsistent moderation outcomes.

### TECHNICAL IMPROVEMENTS

The present embodiments provide concrete technical improvements over such conventional approaches. By embedding classification and extraction models within a procedural function framework, the system achieves high contextual accuracy with a pre-trained large language model (LLM) that does not require retraining. This reduces GPU load, lowers latency, and enables real-time performance on commodity processors. The architecture further supports hybrid synchronous/asynchronous execution: components such as content retrieval operate asynchronously to reduce bottlenecks, while orchestration and prompt construction operate synchronously to preserve coherence. In this way, the system improves throughput and response reliability at scale. In addition, the architecture incorporates mechanisms for drift resistance by decoupling domain-specific content from the LLM's base training, thereby maintaining accuracy and reducing maintenance costs. Collectively, these improvements yield a communication system that is more efficient, scalable, and resilient than conventional NLP-driven group chat platforms.

Presently disclosed system provides a location-based or interest-based communication platform powered by a conversation engine with a flexible and dynamic Al architecture designed to provide modular, context-aware, and dynamic interaction capabilities that enhances the user experience, streamlines content discovery, improves personalization, and provides dynamic content moderation. By using the conversation engine enables the location-based communication platform to provide users with context-aware communications including real-time, intelligent interaction management, and ensures users receive accurate, context-driven responses. For example, instead of relying on static search features, the present system allows users to receive directly from peers who have undergone similar experiences, thereby circumventing the dissemination of misinformation often perpetuated by traditional means. users can query the system directly, which dynamically retrieves relevant information, significantly improving content accessibility.

The conversation engine allows the location-based communication platform to have enhanced functionality (e.g., dynamic and context-aware communication, efficient content discovery, personalized experience, robust content moderation, and scalability) without significantly increasing the computational resources. For example, unlike traditional NLP models that demand significant computing power for training on specific datasets, the present system uses AI architecture model that is lightweight and uses minimal CPU and GPU resources. This efficiency is achieved through its dynamic response generation approach rather than relying on a pre-trained single-purpose model.

By utilizing a backend architecture centered around the conversation engine and leveraging peer-to-peer information sharing, the system aims to create a safer, more informed, and more connected community. The backend components work together to provide a platform where users (e.g., neighborhood residents) can share experiences, access relevant information, and engage in meaningful interactions, ultimately fostering trust and enhancing neighborhood safety. Users get context-aware, immediate responses based on their query, streamlining communication and minimizing the need for repetitive or manual searches.

Users no longer need to sift through hundreds of messages to find relevant information. The system automatically retrieves and presents the most relevant content, significantly improving the efficiency of content discovery.

The present system combines several interconnected components to dynamically create procedural functions, handle multiple datasets, and integrate with external systems, providing more contextually appropriate and tailored responses. In particular, the system includes: (i) classification and extraction models for intent (action triggers) and entity (parameter) recognition, embedded within a procedural function management framework, (ii) a sentiment analysis model, that detects user sentiment in real time without requiring retraining, (iii) a semantic search engine that retrieves semantically relevant content from a pre-stored domain-specific repository, and (iv) a content retrieval and content augmentation tools that dynamically construct prompts for the LLM based on user requests and domain-specific content.

These components work cohesively to interpret user input, execute appropriate actions, and generate accurate, context-aware responses. By embedding classification and extraction models—common to Natural Language Understanding (NLU) but not typically found in Natural Language Processing (NLP)—within a procedural function framework, the system achieves contextual accuracy with a lightweight, pre-trained LLM, rather than relying on the GPU-intensive models used in traditional NLP frameworks.

The system introduces several technical improvements, including enhanced scalability and adaptability. For example, the modular nature of the conversation engine allows for scalability by accommodating a growing number of users and groups with diverse needs. The architecture can easily integrate new features or services, such as dynamic content sharing or real-time event updates, without requiring a complete overhaul. It also supports a stateless design, meaning the system can efficiently manage multiple sessions and interactions without maintaining complex state information, which is particularly useful for handling high user volumes.

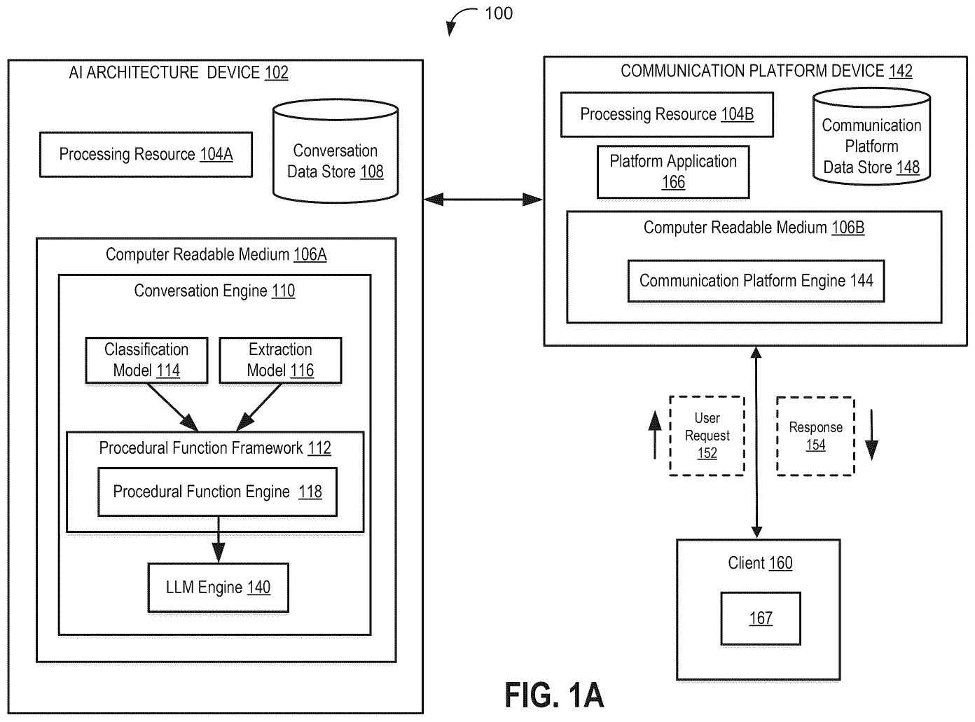

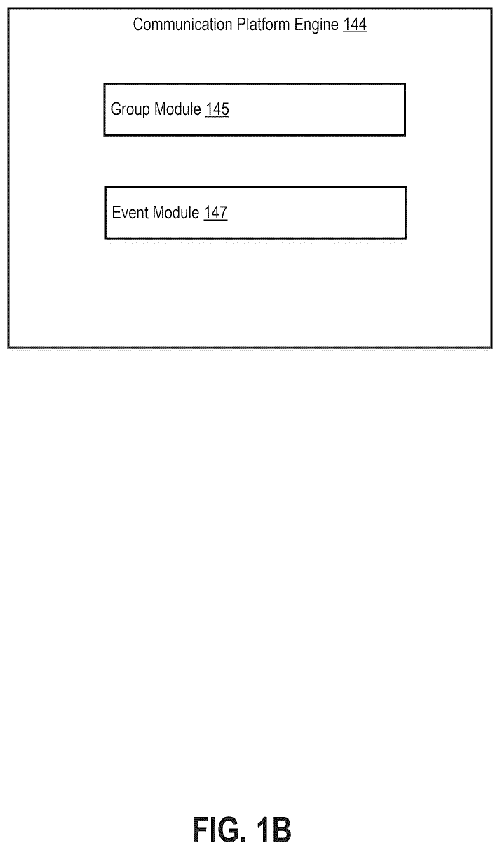

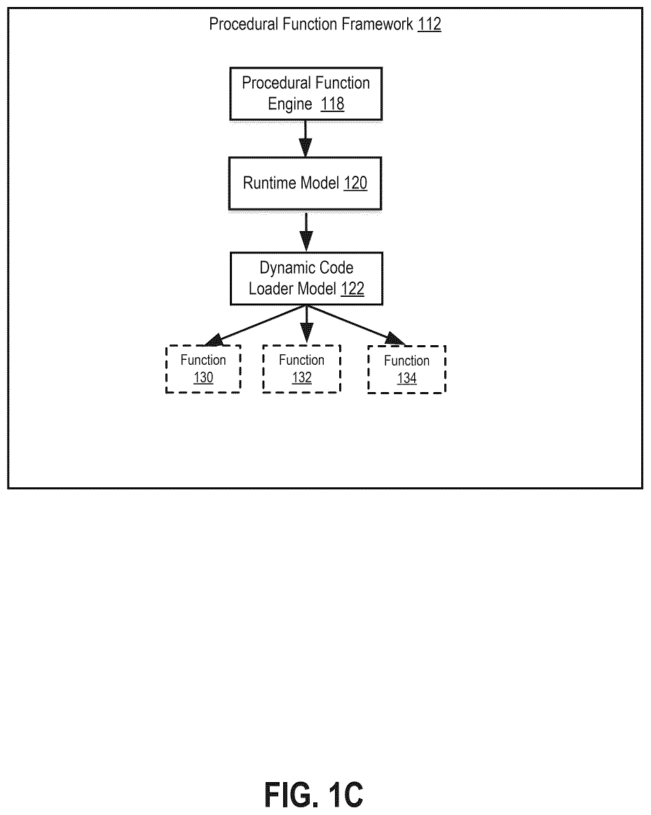

FIG. 1A illustrates an example network 100 including an AI architecture device 102, a communication platform device 142, and a client computing device 160 for providing a modular, context-aware, and dynamic interaction capabilities that significantly enhance the user experience, in accordance with some examples described herein. The AI architecture device 102 and communication platform device 142 may comprise and example processing resource 104 (illustrated as first processing resource 104A and second processing resource 104B) and an example machine-readable medium 106 (illustrated as first machine-readable medium 106A and second machine-readable medium 106B). The processing resource 104 may be implemented using a general-purpose or special-purpose processing engine such as, for example, a microprocessor, controller, or other control logic. The processing resource 104 may be connected to a bus, although any communication medium can be used to facilitate interaction with other components of the corresponding device that embeds processor 104 or to communicate externally. The processing resource 104 may include different types of processing units (also referred to as service provider resources), such as Central Processing Unit (CPU), Graphical Processing Unit (GPU), and the like.

The machine-readable medium 106 may be implemented as random-access memory (RAM) or other dynamic memory, to be used for storing information and instructions to be executed by processor 104. Other memory might also be used for storing temporary variables or other intermediate information during execution of instructions to be executed by processor 104 or a read only memory (“ROM”) or other static storage device coupled to the bus for storing static information and instructions for processor 104.

The machine-readable medium 106 includes memory resources (e.g., cache memory), storage resources (e.g., non-volatile storage devices), and the like. The machine-readable medium 106 may comprise various engines and modules to be executed by processor 104.

For example, at AI architecture device 102, computer readable media 106A may comprise a conversation engine 110. The training and content specific and corresponding data used by the conversation engine 110 may be stored in conversation data store 108.

Similarly, at communication platform device 142, computer readable media 106B may comprise a communication platform engine 144 and a distributed communication platform application 166. User data and other related communication platform data may be stored in communication platform data store 148.

In FIG. 1A, although the network 100 is shown to include AI architecture device 102, communication platform device 142, and a client 160, the network 100 may include any number of systems and clients, without limiting the scope of the present disclosure.

The communication platform engine 144 may comprise a set of processes or operations for optimizing the engine 144 during run-time. For example, a communication platform engine 144 may include a group module 145 and event module, as illustrated in FIG. 1B.

In some embodiments, the communication platform device 142 may include one or more distributed applications implemented on client computing device 160 (e.g., a communication platform application may be distinct from Virtual Assistant application or an event scheduling application) as client applications.

The communication platform device 142 receives a request 152 from a client 160 over the network 100. The communication platform device 142 processes the request 152 using the AI architecture device 102 (e.g., via conversation engine 110). The output of the conversation engine 110 is transmitted back to communication platform device 142 and is implemented as a response 154 to request 152. For example, the response 154 may be implemented within distributed communication platform application 166 accessible to users via a corresponding client communication platform application 167 provided on client 160.

Responses 154 may include responses to specific-user-content-based requests and non-specific-user-based requests. For example, responses 154 to specific-user-content-based requests may include dynamically generated user invitation and coordinating user participation in a location-based chat group (e.g., neighborhood chat croup) or an event-specific chat group (e.g., new resident party), real-time updates about event activities or information relevant to their specific interests, targeted recommendation generated based on user request and/or other relevant data. By contrast, responses 154 to non-specific-user-content based requests may include dynamic content moderation and filtering within a chat group in response to inappropriate content, such as hate speech or bullying, transmission of warnings or protective actions (such as muting or removing participants) when harmful speech is detected, generation of alerts and notification in response to weather, crime, and other location-specific content detection.

In some examples, the network 100 is a distributed network where the Al architecture device 102, the communication platform device 142, and client 160 are located at physically different locations (e.g., on different racks, on different enclosures, in different buildings, in different cities, in different countries, and the like) while being connected via the network 100. In other examples, any combination of the AI architecture device 102, the communication platform device 142 and the client 160 may be co-located, including running as separate virtual devices on the same physical device.

In some embodiments, a distributed communication platform application 166 may be operable by processing resource 104B configured to execute machine-readable instructions of machine-readable medium 106B comprising applications, engines, or modules, including computer program components. In some embodiments, the computer program components may include communication platform engine 144 and/or other such components. The corresponding client communication platform application 167 may be configured to provide client functionality to enable a user to operate a location-based or interest-based communication platform including generating requests 152 and receive responses 154 as implementations within the client communication platform application 167 via a user interface provided on client computing device 160. In some embodiments, the corresponding client communication application 167 may include a chat-based interface. For example, the user may enter natural language commands in an effort to operate the communication platform application 167 to create profiles, join community groups, and participate in various sub-groups (e.g., specialized chats or forums) to share and exchange information with other users in a particular geolocation (e.g., a county, a zip code, city, a town, a neighborhood) or a location-based grouping (e.g., a building, a community, a school district, and so on). In other embodiments, the interface may include a GUI and/or a combination of the chat-based and GUI.

In some embodiments, automated software assistants or bots may be provided via a chat-based interface of the client communication platform application 167 configured to assist the user. For example, the automated assistant or bot may interact with users through text, e.g., via a chat-based interface of the distributed communication platform application 167 by responding to user request. The automated software assistant may be implemented by utilizing the processes of the AI architectures device 102 as described herein.

In some embodiments, client computing device 160 may include a variety of electronic computing devices, such as, for example, a smartphone, tablet, laptop, computer, wearable device, television, virtual reality device, augmented reality device, displays, connected home device, Internet of Things (IOT) device, an enhanced general packet radio service (EGPRS) mobile phone, a media player, a navigation device, a game console, a television, a remote control, or a combination of any two or more of these data processing devices, and/or other devices. In some embodiments, client computing device 160 may present content to user 150 and receive customer message input.

In some embodiments, client computing device 160 may be equipped with GPS location tracking and may transmit geolocation information via a wireless link and network 100. In some embodiments, AI architecture device 102 and/or communication platform device 142, may use the geolocation information to determine a geographic location associated with client 160. For example, AI architecture device 102 and/or communication platform device 142 may use signal strength, GPS, cell tower triangulation, Wi-Fi location, or other input to determine location. In some embodiments, the geolocation of client 160 may be used by AI architecture device 102 and/or communication platform device 142 when identifying location parameters when processing user requests.

As alluded to above, the AI architecture device 102 may comprise conversation engine 110 which is executable by the processing resource 106A to manage real-time interactions between users and the communication platform device 142 to process specific-user-content-based requests and on-specific-user-content based requests (e.g., requests 152), understands the context, and orchestrates responses by leveraging AI models, e.g., a classification model 114 and an extraction model 116 which is integrated with a procedural function framework 112 that includes a procedural function engine 118, and a pre-trained LLM 120.

The conversation engine 110 defines a software architecture to execute components on the AI architecture device 102 for processes user input (i.e., request such as request 152) understands the context, and orchestrates responses (e.g., responses 154) within the location-based or interest-based communication platform provided by communication platform device 142.

The engine 110 ensures that every user interaction is contextually aware and that responses are dynamically generated based on specific conversation or request (e.g., when the request is specific-user-content-based request) and system needs (e.g., when the request is non-specific-user-content-based request). Each component may perform an operation for processing request 152. The request 152 may be provided as input to a classification model 114 and extraction model 116 which may in turn provide their input to procedural function framework 112. The procedural function framework 112 which is integrated with the classification model 114 and extraction model 116 may receive the output generated by models 114 and 116 as input via its procedural function engine 118. In some examples, the procedural function framework 112 may include the pre-trained LLM 140. The output of the procedural function framework 112 may include the response 154 to request 152.

In some embodiments, the classification model 114 is configured to identify the user's goal or purpose behind the request. In speech processing, detecting the goal or purpose means identifying what the user wants to achieve or communicate with their utterance. The classification model 114 detects and categorizes multiple intents from a given input. The classification model 114 helps in guiding the conversation engine 110 to understand which dataset or function to use to respond appropriately to the user's request. In some embodiment, the classification model 114 provides the first layer of understanding to ensure the system knows the user's objective, which directs the flow of information processing. The classification model 114 uses machine learning algorithms, such as natural language processing (NLP), to analyze text and classify it into predefined categories (e.g., “find a residents group for my building,” “report an accident,” “inform others of a criminal incident,” “find social events in my community,” “join a social event” etc.). In some embodiments, the NLP models used for classification tasks in include Logistic Regression (e.g., a model for binary classification tasks), Support Vector Machines (SVMs) (e.g., for separating data into different categories), Neural Networks (e.g., deep learning models like RNNs, Long Short-Term Memory (LSTM) networks, and transformers, which are particularly effective in handling complex language tasks), and other similar models. Once the intent is determined, the procedural function framework 112 uses this information to decide which specific procedural function or set of functions (cells) should be executed to fulfill the user's request.

In some embodiments, the classification model 114 may use supervised learning techniques where it is trained on labeled data. For example, a dataset containing user requests and their corresponding intents is used to train the model. The model 114 learns from this data to predict the correct intent of new, unseen queries. It may also employ advanced NLP techniques, such as transformers or recurrent neural networks (RNNs), to understand the context and nuances of human language. In other words, the model 114 has learned to classify input based on pre-annotated examples. In some embodiments, labeled data may be stored in data store 108 and include manually labeled or annotated data to indicate the correct user intent (i.e., action that the model should be taking) for specific tasks and to provide explicit examples for the model to learn from. The labeled training data stored in data store 108 may include a subset of domain-specific content, e.g., stored in data store 148. In other embodiments, training data and domain-specific data may be stored in the same database 172.

Additionally, the labeled data may include a manually labeled micro-intent and an action attribute. The labeled data may be domain-specific and directly tied to a particular task (e.g., obtaining loan-related information). For example, intent identification data may have labels indicating the specific user intent that can be associated with each sentence.

Once the training data has been labeled, it can be used to train the classification model 114 to process labeled user requests to determine user intent.

The classification model 114 learns from the sample data which has been labeled. The more sample data is provided to the model the more accurate the model will be at detecting a particular intent.

The extraction model 116 is used to identify and extract parameters (or entities) from the user's input. Parameters (or entities) are specific pieces of information or data points that provide context or details necessary to complete the action associated with the detected intent (e.g., names, dates, locations, quantities) of the user made by model 114. In speech processing, identifying parameters (or entities) means extracting meaningful and relevant pieces of data from the user's input. The extraction model 116 tags relevant parameters (or entities) in the input text and extracts a set of query parameters associated with the identified query intent. In some embodiments, the extraction model 116 may obtain parameters from a domain-specific database.

The extraction model 116 uses machine learning algorithms, such as natural language processing (NLP), to o recognize and extract these parameters (or entities) from text. In some embodiments, the NLP models used for classification tasks in include Named Entity Recognition (NER): (e.g., a model for binary classification tasks), Conditional Random Fields (CRF) (e.g., a probabilistic model often used for structured prediction, particularly effective for sequence tagging tasks like entity extraction), Neural Networks (e.g., Recurrent Neural Networks (RNNs), Long Short-Term Memory (LSTM) networks, and transformers, which can handle complex patterns in language and context), Named Entity Recognition (NER) Models (e.g., based on machine learning algorithms like CRFs, HMMs (Hidden Markov Models), or deep learning approaches), Transformer-Based Models: Such as BERT (Bidirectional Encoder Representations from Transformers) or GPT (Generative Pre-trained Transformer), which can understand context and extract entities with high accuracy, and other similar models. The extracted parameters (or entities) serve as parameters or arguments for the procedural functions of procedural framework 112 that are executed. The procedural function framework 112 dynamically uses these parameters (or entities) to ensure that the correct data is used in each function.

The extraction model 116 may be trained using supervised learning techniques with labeled datasets, where the training data includes examples of text annotated with the entities that the model needs to recognize. The labeled training data used to train the extraction model 116 is described above, in reference to the classification model 114.

### PROCEDURAL FUNCTION ENGINE 118

The procedural function framework 112 leverages both the classification model 114 (for detecting intents) the extraction model 116 (for identifying entities) to understand user requests and uses engine 118 which creates and executes procedural functions based on the detected user intent and entities to identify the user's intent. For example, based on the identified intent, engine 118 determines which functions or workflows need to be executed by engine 118 to address the identified intent. In some embodiments, this selection may be based on predefined mappings between detected intents and the available functions. In other embodiments, engine 118, may dynamically determine and generate the functions. Simultaneously, engine 118 utilizes extraction model 116 to pull out relevant entities from the input. These entities provide the necessary details that the functions require to perform the desired task. Together, these models enable the engine 118 to dynamically execute the appropriate functions or workflows needed to fulfill the user's request, making the system flexible, adaptable, and capable of handling diverse tasks in real-time. In some embodiments, engine 118 may act as a central controller or orchestrator that determines which procedural functions should be executed to fulfill the user's request.

In some embodiments, input from classification model 114 and extraction model 116 used by procedural function framework 112 to generate a partial and a full response. For example, engine 118 may receive output from the classification model 114 (intents) and the extraction model 116 (entities) extracted from the query and execute one or more actions which will formulate the response for a query comprising raw data entered by the user. In some embodiments, the engine 118 may be configured to generate a partial response. In some embodiments, the partial response generated by the engine 118 may comprise the raw output data which has been transformed into a simplistic phrase to produce a partial response. The partial response generated by engine 118 may be submitted to LLM 140 to produce the final response. In some embodiments, LLM 140 used to produce the final response may comprise a pre-trained LLM developed using an open-source LLM model (OpenChatKit) that uses 7 billion parameters and a Generative Pretrained Transformer (GPT) algorithm.

In some embodiments, procedural function framework 112 may comprise a runtime model, which is a specific component or module within the engine 118. For example, as illustrated in FIG. 1B, Runtime model 120 may be configured to execute the decisions made by the engine 118, particularly concerning which procedural functions to run and how they should be executed, as illustrated in FIG. 1B. Runtime model 120 may handle the real-time execution of procedural functions based on the intent and entity information provided by models 114 and 116, respectively. It serves as the runtime environment where decisions are operationalized, converting the output of the intent and entity detection into specific actions performed by the procedural functions. The runtime model 120 may use a command selector (not illustrated) to determine which procedural functions to execute based on the identified intents and extracted entities.

In some embodiments, runtime model 120 may comprise a dynamic code loader 122 that dynamically loads and executes the required procedural functions 130, 132, 134 based on the decisions made by the runtime model 120, ensuring that the right functions are run at the right time. A configuration file containing the list of all supported intents and the actions associated with them may be used.

Each of the functions 130, 132, 134 is a dynamic, procedural function or unit of execution that is created or utilized to perform specific tasks based on user requests. Multiple functions can be triggered to generate a complex response. Exemplary functions may include an API Call Function (e.g., for sending a request to an external API to fetch data or perform an action, a Data Processing Function (e.g., for processing input data to perform calculations, transformations, or analysis), a Web Search Function (e.g., for conducting a web search to find external information not available in the current dataset), an Interaction Function (e.g., for communicating with other AI systems or services to exchange information or trigger additional tasks).

In some embodiments, procedural functions 130-134, i.e., individual execution units may include logic-based routines, or task-specific scripts that perform discrete operations. For example, a function may include if/else logic. Such functions would not “learn” from data in the way neural networks do. Instead, they are invoked dynamically based on the identified intents and extracted entities to perform predetermined actions. Unlike neural networks, which are trained models that learn patterns from data, functions that are rule-based or pre-defined are designed to execute specific tasks.

In some embodiments, procedural functions, i.e., individual executions units may use neural network functions that are designed to handle specific tasks associated with the intent. A neural network is a computational model inspired by the way biological neural networks in the human brain process information. It consists of interconnected layers of nodes (neurons) that work together to learn patterns, representations, and relationships in data.

For example, certain content (e.g., unrelated to the topic) might activate a specific neural network node trained to handle functions like content moderation, bullying content detection, harmful speech detection and so on. Similarly, the extracted entities may serve as inputs or parameters for the neural network node. For example, the neural network node handling content moderation would receive additional contextual input such as sentiment predictor data, other user responses, and so on, as inputs to predict the harmful speech. The neural network nodes may be dynamically invoked to manage specific actions such as removing users, creating a chat group for a location, creating a chat group for a location-based event, querying databases, handling updates, or sending notifications, making the system flexible, adaptable, and capable of handling diverse tasks in real time. By utilizing a neural network for a computational model for the procedural function engine allows the engine to learn patterns and make predictions based on data including generating new functions.

In some embodiments, the runtime model 120 may be configured to execute the decisions made by the engine 118, particularly concerning which procedural functions to run and how they should be executed, as illustrated in FIG. 1B. Runtime model 120 may handle the real-time execution of procedural functions based on the intent and entity information provided by models 114 and 116, respectively.

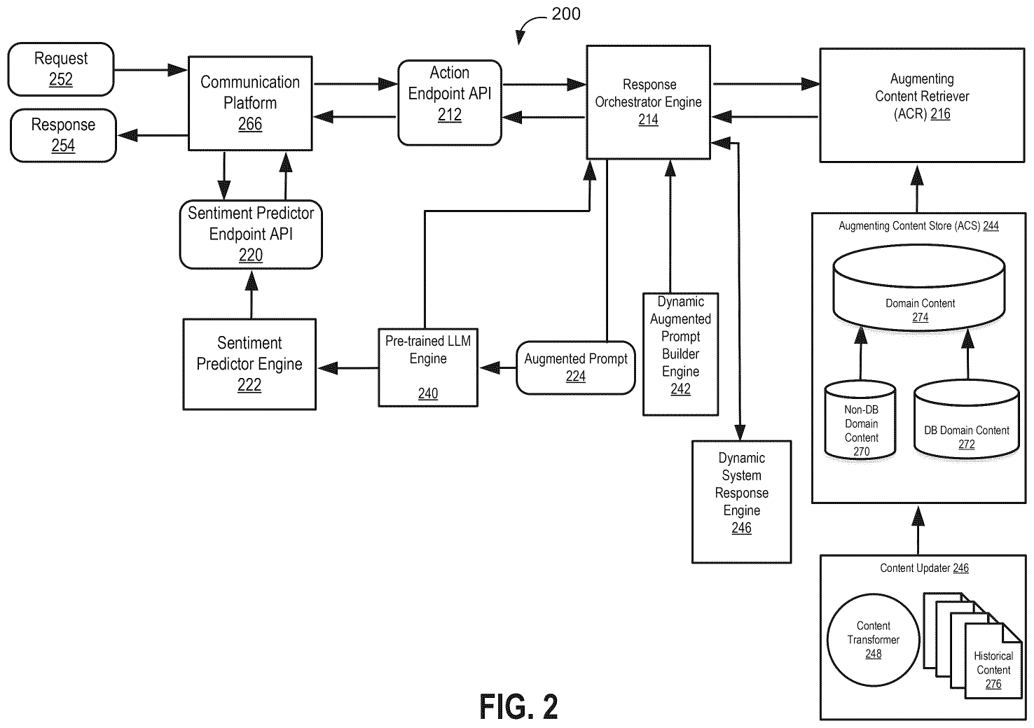

FIG. 2 is an illustrative process for generating a response to a request using procedural functions generated and executed by the procedural function framework 112 of conversation engine 100, in accordance with some examples described herein. In example 200, a process associated with generating a response is illustrated using various system, including a system comprising a conversation engine. The system executing machine-readable instructions in example 200 may correspond with AI architecture device 102 in FIG. 1A.

A new request 252 may be generated via communication platform 266, which may be implemented with an AI architecture device 102 illustrated in FIG. 1A and may correspond with distributed communication platform application 166 in FIG. 1A. The request 252 may correspond specific-user-content-based requests and non-specific-user-content based requests, as explained above. The specific-user-content-based requests may include direct requests (e.g., natural language queries or questions provided via a user interface) or indirect requests (e.g., user of user specific information, including location-based or interest information to generate recommendations or contextually relevant information such as localized content about weather, traffic, schools, and community events, driven by data aggregated in the backend. The non-specific-user-content based requests may include system generated requests in response to data by any user within the communication platform for the purpose of user moderation, content moderation, and/or event scheduling.

Communication platform 266 simultaneously sends request 252 to a request endpoint application programming interface (“API”) 212 for response generating tasks and to a sentiment predictor endpoint application programming interface (“API”) 220 for sentiment detection tasks. The action endpoint API 212 receives the request from the user chat interface 266 and forwards it to the response orchestrator engine 214 for processing. As alluded to earlier, the request 252 may be based in specific-user-content-based requests or non-specific-user-content-based requests. Response orchestrator engine 214 may be a central coordination module that receives user request 252 from the action endpoint API 212 and manages interactions with other system components. Response orchestrator engine 214 orchestrates the retrieval of relevant content, prompt construction, activation of the LLM for response generation, and/or dynamic system response engine 246 (specifically concerning system generated requests in response to data by any user within the communication platform for the purpose of user moderation, content moderation, and/or event scheduling).

Simultaneously, as the request endpoint API 212 receives the request 252, the sentiment predictor endpoint API 220 also receives user request 252 and forwards the input to a sentiment predictor engine 222.

Sentiment predictor engine 222 utilizes LLM 240 to analyze the sentiment of the content in “sentiment prediction mode,” by generating a sentiment classification (e.g., “negative” or “non-negative”). For example, the content analyzed by engine 222 may include user-content based requests (e.g., user's questions for information, request for a recommendation) and non-user-based requests (e.g., content in a chat group being monitored for bullying). The LLM 240 may be a pre-trained LLM and may comprise an open-source large language model (such as OpenChatKit) with generative capabilities, utilizing a generative pretrained transformer (GPT) algorithm. The LLM 240 may be invoked twice: first for sentiment analysis and second for generating a response based on the dynamically constructed prompt, as described herein.

The response orchestrator engine 214 calls the augmenting content retriever (ACR) engine 216 to find relevant content from the augmenting content store (ACS) 244 using a semantic search engine. For example, the ACR engine 216 uses a semantic search engine (e.g., FAISS) to search for and retrieve content from the ACS 244 that semantically matches the user's request.

The ACS 244 comprises a repository pre-populated with domain-specific content, organized for efficient retrieval. The ACS 244 may include domain content 274 which may be a knowledgebase populated with data generated during the peer-to-peer communications within the communication platform 266. For example, the ACS 244 may include domain content data store 274, which may correspond with the domain content data store 174 in FIG. 1A. The ACS 244 may also dynamically incorporate content retrieved via API calls and database look-ups. In some embodiments, the ACS 244 may include workflows and/or chat interfaces generated in response to requests.

The data in domain content datastore 274 may include to structured data 270 and unstructured data 272. The structured data 270 includes information that is typically organized in tables and can be queried using database management systems (DBMS) like SQL, NoSQL, or other types of databases. This data 270 is highly structured, following a specific schema or format (e.g., rows and columns in relational databases, document-based storage in NoSQL databases). Furthermore, this content 270 may be specific to the domain or context of the community group or sub-group. It could include records such as user information, login information, request information generated and response information received, request topic, response topic, and other relevant request details. The content 270 can be dynamically updated as new data is entered or modified in the database. For example, structured data 270 may include information about schools, and community events, vendors, service providers, rules and regulations and/or other location-related information.

The unstructured data 272 includes content that is not stored in a structured database but is still specific to the company or domain. This content 272 could be in the form of documents, files, internal reports, manuals, emails, presentations, or any other format that is stored outside traditional databases. While data 272 it is specific to the organization's domain it is often unstructured (e.g., text documents, PDFs, presentations) or semi-structured (e.g., JSON files, XML data) and it resides in different formats and storage systems. The unstructured data 272 may come in various formats, such as Word documents, PDFs, images, spreadsheets, or even web pages within the company's intranet, and other similar formats. For example, unstructured data 272 may include school recommendation lists, community rule books, neighborhood guides, event flyers, and similar information. Both structured data 270 and unstructured data 272 play crucial roles in providing comprehensive answers to user queries. For example, when the ACR engine 216 retrieves content relevant to the user's query, that content may either be structured data 270 (i.e., data that directly answers or supports the user's question) or unstructured data 272 (i.e., by performing a semantic search (e.g., using FAISS) across unstructured or semi-structured content 272 to find documents, articles, or other files relevant to the query. Accordingly, the ACR engine 216 retrieves and integrates both structured data 270 and unstructured data 272 content and then used by the dynamic augmented prompt builder (DAPB) engine 242 to create a tailored prompt for the LLM 224, which includes instructions and the most relevant content slices so that the conversation allowing engine 110 can construct a comprehensive and context-aware response.

In some embodiments, the data in the ACS 244 is continuously updated and maintained with relevant and up-to-date content with a content updater 246. By using content updater 246, ensures that the content is used to enrich the responses generated by the system, ensuring that the answers provided are accurate, current, and contextually relevant.

The content updater 246 collects new data from multiple sources (such as external APIs, databases, real-time feeds, or internal repositories) and integrates this content into the ACS 244. It ensures that the information in the ACS 244 remains fresh and relevant by regularly adding new data and removing outdated or irrelevant information.

The content updater 246 dynamically enhances the knowledge base by incorporating recent, domain-specific content that is pertinent to the user's queries. For example, if the system is used in a homeowners'association setting (HOA) setting, it may retrieve updated HOA policy and rules documents, management company details, FAQs, and other such relevant information that are then stored in the ACS 244 for future use. By keeping the ACS 244 up-to-date, the system is able to generate responses based on the latest available information, enhancing the accuracy and relevance of the answers provided to users.

The content updater 246 integrates with external content sources (such as APIs, web crawlers, or news feeds) and internal databases or knowledge management systems. This allows it to retrieve relevant content in real time, ensuring that the system always has access to the most current data. For example, in an enterprise scenario, content updater 246 may pull data from CRM systems, employee handbooks, or product catalogs to enrich responses to user requests.

Before updating the ACS 244, the content updater 246 preprocesses the content to ensure that it is properly formatted and indexed for fast retrieval. This may include removing irrelevant or sensitive data, parsing and structuring the content in a way that makes it easily searchable, creating metadata tags or labels that improve the accuracy of search results when the system queries the ACS 244. In some embodiments, content transformer 248 is configured in taking raw, unstructured, or semi-structured data (e.g., text, documents, files) retrieved by the content updater 246 from external APIs, internal databases, or other content sources and transforming it into a structured and useful format before it is stored in the ACS 244.

The content updater 246 works closely with the ACR engine 216 to ensure that the content retrieved during user interactions is relevant and up-to-date. The content updater 246 also collaborates with the dynamic augmented prompt builder (DAPB) engine 242 to ensure that the system has access to enriched content that can be used to build detailed and contextually relevant prompts for the LLM 240.

In some embodiments, historical content 276 is used to provide context and enhance the relevance of new content being added by the content updater 246. By referencing past content, the system can maintain continuity and context in responses. Historical content 276 could include previous chat interactions, older versions of documents, or past event data. This helps the system provide consistent answers that reflect both new information and historical trends or patterns. The content updater 246 can reference historical content 276 to identify trends or patterns that inform how new content should be integrated into the ACS 244. For instance, if a pattern of user requests shows increasing interest in a particular topic or subject, this may influence how content is prioritized and updated. By leveraging historical content 276, the system can predict what type of information might be most relevant based on previous interactions and update the store accordingly. When a user asks a question, the ACR engine 216 may pull both real-time and historical content 276 to ensure that the response is accurate and reflects any updates or changes over time. The content updater 246 ensures that historical and current data are harmonized in the ACS.

The response orchestrator engine 214 sends the retrieved content to the dynamic augmented prompt builder (DAPB) engine 242, which may be configured to construct a prompt comprising an instruction and relevant content slices retrieved by the ACR engine 214.

The response 254 is sent back to the chat orchestrator 214, which forwards it to the request endpoint API 212 for delivery to the communication platform application 166.

For example, if the request 252 was specific-user-content-based request (i.e., request based on data directly or indirectly generated by a specific user of the platform such as a neighbor looking for chat groups) the response 254 will be implemented within the interface 266. For example, responses 254 to specific-user-content-based requests may include providing user with an ability to: (i) participate in group chats with other residents within the same location (city, neighborhood, or building); (ii) receive aggregated and customized content and personalized recommendations based on user requested topic or criteria (e.g., zip code or location-specific data) resulting in user receiving contextually relevant information, such as localized content about weather, traffic, schools, and community events; (iii) create profiles, join community groups, and participate in specialized sub-groups or forums; (iv) join and/or participate in a location-based chat group (e.g., neighborhood chat croup) or an event-specific chat group (e.g., new resident party) through dynamically generated user invitation; (v) integrate into specific events thereby allowing users to engage in real-time communication with others at the same location including sharing event-specific information, such details about guests, schedule of events, promotions, and other relevant aspects of the gathering (the events may be dynamically generated in some embodiments); (vi) contribute to and access a shared photo album during events, thereby enhancing collaboration and community building by enabling attendees to collectively create visual memories; and (vii) receive real-time automated alerts and updates generated by automatically monitoring of incidents (accidents, crime, traffic congestion) through social media platforms, local news feeds, and other content sources used to aggregate relevant updates (the alerts and updates may be distributed to communication platform users (e.g., neighborhood residents)). Some of these responses 254 may be responsive to requests that were directly generated by the user. For example, answers to specific questions, requests to join a group and so on. In some embodiments, responses 254 may be responsive to requests that were not directly generated by the user. For example, user may be provided with curated and customized content based on user earlier provided location and preference information.

Although the foregoing examples illustrate community or HOA use cases, the same architecture may be applied more broadly. In an emergency response context, multiple users reporting the same incident can be aggregated, semantically clustered, and validated in real time to generate prioritized alerts for first responders. In commerce scenarios, the extraction model may parse vendor preferences from user queries to recommend local service providers or marketplace listings. In educational settings, location-based chat groups can be dynamically created for schools, campuses, or extracurricular events, with the AI engine surfacing domain-specific resources such as syllabi or campus safety alerts. In healthcare and wellness contexts, group chats may be sentiment-monitored for early signs of distress, allowing escalation to trained professionals or automated delivery of support resources. These expanded use cases demonstrate that the disclosed architecture is not limited to neighborhood forums but is extensible to any domain where location, context, and dynamic peer interaction are relevant.

By contrast, responses 254 to non-specific-user-content based requests may include dynamic content moderation and filtering within a chat group in response to inappropriate content, transmission of warnings or protective actions (such as muting or removing participants) when harmful speech is detected, generation of alerts and notification in response to weather, crime, and other location-specific content detection.

For processing non-specific-user-content based requests, the communication platform device 142 (illustrated in FIG. 1A) may utilize conversation engine 110 including, as illustrated in FIG. 2, and described above. For example, the conversation engine 110 may analyze chat messages and other content generated by users via application 167 for inappropriate language, hate speech, or other forms of offensive or harmful content (e.g., profanity, bullying, harassment), allowing the communication platform device 142 automatically delete such content or flag it for further review. The content may be provided as input to the classification model 114 and extraction model 116 which may in turn provide their input to procedural function framework 112.

In some embodiments, conversation engine 110 may be used to detect repeated negative behaviors, such as spamming, trolling, or cyberbullying. Machine learning models may track patterns in user behavior, recognizing when a user is consistently breaking community guidelines. By understanding the tone of conversations, the conversation engine 110 may detect when interactions become heated or aggressive. If a conversation seems likely to escalate into conflict, the conversation engine 110 may take preventive action, such as issuing warnings, cooling down the conversation, or alerting moderators.

In cases of severe misconduct, the conversation engine 110 may automatically mute or ban users temporarily or permanently, depending on the infraction. These actions may be based on predefined rules or customizable thresholds for infraction.

In some embodiments, the conversation engine 110 may recognize and block spamming activities, such as posting the same message multiple times, sharing irrelevant links, or promoting unauthorized content (e.g., phishing links or advertising).

In some embodiments, the conversation engine 110 may be configured to use specific rules based on the group's guidelines. For example, certain words or phrases may be flagged or prohibited, or specific behavior thresholds can trigger warnings or actions. Referring now to FIG. 2, the ACS 244 may include group rules or guidelines rules. The rules may be updated with historical data obtained from historical group interactions, outside reference and content sources for slang vocabularies, crime databases including phishing techniques and other such similar content.

In some embodiments, additional security and trust mechanisms are provided. For example, the system may verify geolocation inputs using multiple modalities (GPS, Wi-Fi triangulation, and device fingerprinting) to prevent location spoofing. Requests and responses may be subject to anonymization, where personally identifying fields (names, phone numbers, or exact street addresses) are masked or replaced with pseudonyms before being shared peer-to-peer. The conversation engine may also maintain an audit log of procedural functions executed in response to sensitive requests, enabling compliance with data governance requirements. In some embodiments, moderation functions include adversarial content detection trained to recognize attempts at poisoning the semantic search index or injecting harmful prompts. The system may additionally execute within a secure enclave or trusted execution environment, ensuring that intermediate outputs of classification, extraction, or sentiment analysis remain confidential and tamper-resistant. These features provide technical guarantees of privacy, integrity, and trustworthiness in addition to enhanced functionality.

The components described in FIG. 2 may be initiated as procedural functions of procedural function engine 118 of the conversation engine 110 described above. For example, when a request is received (e.g., a request 152 in FIG. 1A or request 252 in FIG. 2), the engine 118 may generate a procedural function to initiate the sentiment predictor engine 222. This function uses the pre-trained LLM 240 in “sentiment prediction mode” to analyze the sentiment of the request. Simultaneously, another procedural function may be generated to activate a chat orchestrator 214, which coordinates with the ACR engine 216 to search and retrieve relevant content from the ACS 244.

Once the relevant content is retrieved, the engine 118 may generate a procedural function to call the DAPB engine 242, which constructs a tailored prompt for the Pre-Trained LLM 240. This prompt combines the user's request with the retrieved content to ensure that the response generated by the LLM 240 is accurate and context specific. The DAPB engine 242 creates an enriched or refined prompt that includes additional context or instructions, which can be fed to the LLM 140 (illustrated in FIG. 1) in the conversation engine 110 to enhance its understanding and improve the quality of the response. The ACR 216 fetches relevant data from various content stores (e.g., knowledge bases, databases such as 174 illustrated in FIG. 1A), which can be incorporated into the LLM's input to provide more comprehensive answers. The sentiment predictor engine 222 output can guide the LLM 240 (and LLM 140 in FIG. 1A) to adjust the tone or style of its responses based on the user's perceived sentiment, ensuring a more empathetic or appropriate reply.

The LLM component 140 in FIG. 1A (in the conversation engine 110) may include architecture that can be designed to take combined inputs from both: its own ecosystem (e.g., classification model 114, extraction model 116, and procedural function engine 118) and the components identified in FIG. 2. For example, the LLM 114 in FIG. 1A might receive enriched prompts that have been dynamically built by combining the output of the classification model 114, extraction model 116 with additional content fetched or generated by the FIG. 2 components described above. Further, the LLM component 140 in FIG. 1A (in the conversation engine 110) can use outputs from FIG. 2, like data retrieved by the ACR engine 216 (in FIG. 2), to answer user requests more accurately by leveraging updated or external data sources. Inputs such as sentiment analysis results or context from the response orchestrator engine 214 can be used by the LLM 140 (in FIG. 1A) to adapt its responses to be more relevant and aligned with user expectations.

In some embodiments, some of the engines and/or components in Al architecture device 102 may be characterized by being synchronous or asynchronous. Synchronous engines and/or components operate in a sequential, blocking manner, meaning they perform their tasks in a specific order and wait for each step to complete before moving on to the next one. These components require an immediate response or result before continuing to the next operation. For example, a synchronous component, waits for the completion of its current task before proceeding to the next task. It does not perform other operations while waiting. Each task is executed in a predefined order, one after another. These components need an immediate result or output from their processes to continue, which can make them more predictable but less flexible in handling multiple tasks simultaneously.

For example, the response orchestrator engine 214 may operate synchronously to ensure that it sequentially coordinates all steps necessary for generating a response. It may wait for the ACR engine 216 to finish retrieving content before moving to the next step (e.g., such as passing content to the dynamic augmented prompt builder (DAPB) 242). DAPB engine 242 in turn constructs a prompt for the LLM 240 based on the content retrieved. DAPB engine 242 operates synchronously in that it waits for all necessary content to be available before creating and forwarding the prompt to the LLM 240. Finally, LLM 240 may be invoked synchronously to generate a response based on the constructed prompt, meaning that the system waits for the LLM 240 to complete its generation task before continuing to the next process.

By contrast, asynchronous components operate in a non-blocking manner, meaning they initiate tasks that run independently and do not wait for those tasks to complete before moving on to other operations. These components can handle multiple tasks concurrently and do not require immediate responses to continue processing. For example, an asynchronous component does not wait for a task to complete before starting another task. It can handle multiple tasks simultaneously. Tasks can be executed in parallel or independently, allowing for more flexible and efficient use of system resources. Often, asynchronous modules use event-driven mechanisms or callbacks to handle tasks once they are completed.

In some embodiments, sentiment predictor engine 222 may be configured to operate asynchronously, allowing the sentiment predictor endpoint API 220 to send the user's input to the LLM 240 in a “sentiment prediction mode” without blocking other processes (like content retrieval or prompt construction). Once the sentiment analysis is complete, the result can be asynchronously passed back to the relevant module or process. The ACR engine 216 may be configured to perform content retrieval asynchronously, enabling the system to start retrieving content from the ACS 244 while other tasks are being processed in parallel. This can speed up the overall workflow by ensuring that content retrieval does not block other tasks.

Synchronous operations (e.g., Response orchestrator engine 214, DAPB engine 242, and/or LLM 240) ensure that critical steps requiring a defined sequence (like prompt construction and LLM response generation) are executed in order, maintaining coherence and accuracy in the response. Asynchronous operations (e.g., ACR engine 216 and/or ACS 244) allow the system to perform background tasks (like sentiment detection or content retrieval) concurrently, reducing delays and optimizing overall processing time. By virtue of combining both types of modules allows the system to optimize performance, ensuring accurate and context-aware responses while maintaining efficiency and scalability.

In alternative embodiments, the procedural functions may be distributed between cloud and edge devices. For example, lightweight classification and extraction routines may run directly on a client device to preserve responsiveness, while more complex orchestration and semantic search functions run on a cloud-based AI architecture device. In another embodiment, augmenting content retrieval may integrate directly with external APIs, such as civic data feeds, emergency alert systems, or commerce databases, to supplement locally stored domain content. In yet another embodiment, federated learning techniques may be employed so that client devices contribute updated micro-models for intent classification without central retraining, thereby improving accuracy while preserving user privacy. These alternative designs provide deployment flexibility across enterprise, consumer, and civic infrastructures.

AI drift occurs when a machine learning model's performance degrades over time due to changes in the underlying data distribution or evolving user behavior and requirements. This can lead to inaccuracies in the model's predictions or outputs, necessitating frequent retraining to maintain performance. The described AI architecture device 102 minimizes or eliminates AI drift by using a well-trained, pre-trained LLM 140 (and LLM 240 in FIG. 2) that is robust and comprehensive in its understanding of natural language. Instead of relying on the LLM to store domain-specific knowledge that may change over time, the system dynamically retrieves the most relevant and up-to-date content at runtime using ACR engine 216 and ACS 244 illustrated in FIG. 2. By decoupling the LLM 140 and/or 240 from domain-specific content that might evolve, the system ensures that the LLM 140 and/or 240 remains effective over time without the need for retraining. The LLM 140 and/or 240 generates responses based on dynamically retrieved content, which is always current, thus preventing drift caused by outdated information. The AI architecture device 102 maintains high accuracy in its outputs by continuously using up-to-date domain-specific content without modifying the core LLM 140 and/or 240.

Since the LLM 140 and/or 240 does not directly handle evolving content, its understanding of language remains consistent, avoiding drift and ensuring stable performance. Eliminating AI drift reduces the need for ongoing monitoring, evaluation, and correction of model performance, resulting in lower maintenance overhead.

In traditional AI and machine learning systems, retraining is required whenever there is a significant change in domain-specific content or user behavior. Retraining an LLM is a resource-intensive process that requires substantial computational power, time, and data. It also involves high costs associated with cloud infrastructure, storage, and human resources.

The disclosed AI architecture device 102 avoids the need for retraining by leveraging a pre-trained, generic LLM 140 and/or 240 combined with a dynamic content retrieval approach. Instead of embedding domain-specific knowledge directly within the LLM 140 and/or 240, the AI architecture device 102 dynamically retrieves relevant content from the ACR engine 216 and ACS 244, illustrated in FIG. 2, and feeds this content to the LLM 140 and/or 240 at runtime. The conversation engine 110 dynamically generates procedural functions that guide the retrieval of up-to-date content and construct enriched prompts for the LLM 140 and/or 240, ensuring that the LLM 140 and/or 240 always operates with the most relevant information without requiring any updates to its core training.

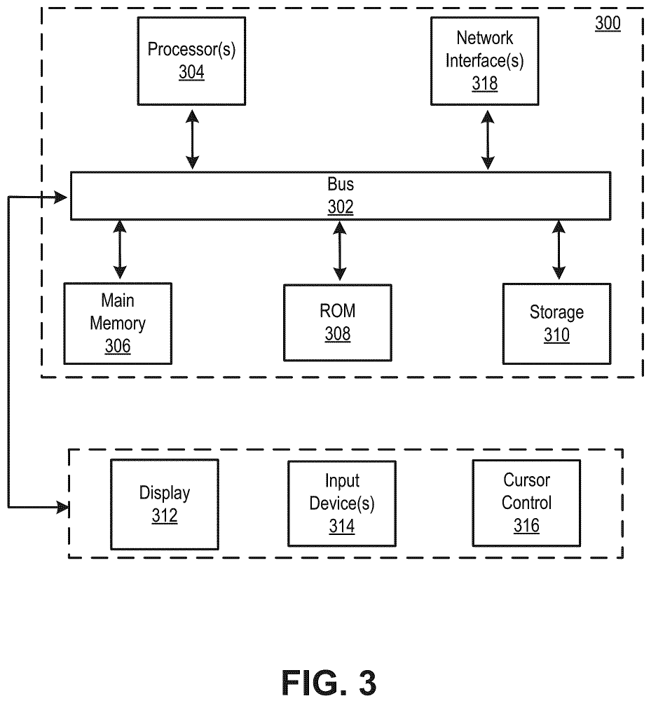

By eliminating the need for frequent retraining, the system significantly reduces computational costs and energy consumption. It avoids the expenses associated with the infrastructure and human resources required for training large-scale models. The conversation engine 110 can easily scale across different domains and datasets without the overhead of retraining. New data sources and location-based knowledgebase can be integrated by updating the content retrieval mechanisms rather than modifying the LLM 140 and/or 240 itself. The Al architecture device 102 remains lightweight and efficient, using minimal CPU and GPU resources. The pre-trained LLM 140 and/or 240 does not need to be retrained, which makes the architecture suitable for real-time applications where low latency and quick response times are crucial. The AI architecture device 102 can rapidly adapt to changes in domain-specific content or user needs by updating the content in the ACS 244 illustrated in FIG. 2 rather than retraining the LLM 140 and/or 240. This allows the system to handle dynamic and evolving knowledgebase efficiently.

Where components, logical circuits, or engines of the technology are implemented in whole or in part using software, in one embodiment, these software elements can be implemented to operate with a computing or logical circuit capable of carrying out the functionality described with respect thereto. One such example computing module is shown in FIG. 3. Various embodiments are described in terms of this example computing module 400. After reading this description, it will become apparent to a person skilled in the relevant art how to implement the technology using other logical circuits or architectures.

FIG. 3 illustrates an example computing module 300, an example of which may be a processor/controller resident on a mobile device, or a processor/controller used to operate a payment transaction device, that may be used to implement various features and/or functionality of the systems and methods disclosed in the present disclosure.

As used herein, the term module might describe a given unit of functionality that can be performed in accordance with one or more embodiments of the present application. As used herein, a module might be implemented utilizing any form of hardware, software, or a combination thereof. For example, one or more processors, controllers, ASICs, PLAS, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the application are implemented in whole or in part using software, in one embodiment, these software elements can be implemented to operate with a computing or processing module capable of carrying out the functionality described with respect thereto. One such example computing module is shown in FIG. 3. Various embodiments are described in terms of this example-computing module 400. After reading this description, it will become apparent to a person skilled in the relevant art how to implement the application using other computing modules or architectures.

Referring now to FIG. 3, computing module 300 may represent, for example, computing or processing capabilities found within desktop, laptop, notebook, and tablet computers; hand-held computing devices (tablets, PDA's, smart phones, cell phones, palmtops, etc.); mainframes, supercomputers, workstations or servers; or any other type of special-purpose or general-purpose computing devices as may be desirable or appropriate for a given application or environment. Computing module 300 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 300 might include, for example, one or more processors, controllers, control modules, or other processing devices, such as a processor 304. Processor 304 might be implemented using a general-purpose or special-purpose processing engine such as, for example, a microprocessor, controller, or other control logic. In the illustrated example, processor 304 is connected to a bus 302, although any communication medium can be used to facilitate interaction with other components of computing module 300 or to communicate externally. The bus 302 may also be connected to other components such as a display 312, input devices 314, or cursor control 316 to help facilitate interaction and communications between the processor and/or other components of the computing module 300.

Computing module 300 might also include one or more memory modules, simply referred to herein as main memory 306. For example, preferably random-access memory (RAM) or other dynamic memory might be used for storing information and instructions to be executed by processor 304. Main memory 306 might also be used for storing temporary variables or other intermediate information during execution of instructions to be executed by processor 304. Computing module 300 might likewise include a read only memory (“ROM”) 308 or other static storage device 310 coupled to bus 302 for storing static information and

### Instructions for Processor 304.

Computing module 300 might also include one or more various forms of information storage devices 310, which might include, for example, a media drive and a storage unit interface. The media drive might include a drive or other mechanism to support fixed or removable storage media. For example, a hard disk drive, a floppy disk drive, a magnetic tape drive, an optical disk drive, a CD or DVD drive (R or RW), or other removable or fixed media drive might be provided. Accordingly, storage media might include, for example, a hard disk, a floppy disk, magnetic tape, cartridge, optical disk, a CD or DVD, or other fixed or removable medium that is read by, written to or accessed by media drive. As these examples illustrate, the storage media can include a computer usable storage medium having stored therein computer software or data.

In alternative embodiments, information storage devices 310 might include other similar instrumentalities for allowing computer programs or other instructions or data to be loaded into computing module 300. Such instrumentalities might include, for example, a fixed or removable storage unit and a storage unit interface. Examples of such storage units and storage unit interfaces can include a program cartridge and cartridge interface, a removable memory (for example, a flash memory or other removable memory module) and memory slot, a PCMCIA slot and card, and other fixed or removable storage units and interfaces that allow software and data to be transferred from the storage unit to computing module 300.

Computing module 300 might also include a communications interface or network interface(s) 318. Communications or network interface(s) interface 318 might be used to allow software and data to be transferred between computing module 300 and external devices. Examples of communications interface or network interface(s) 318 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications or network interface(s) 318 might typically be carried on signals, which can be electronic, electromagnetic (which includes optical) or other signals capable of being exchanged by a given communications interface. These signals might be provided to communications interface 318 via a channel. This channel might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media such as, for example, memory 306, ROM 308, and storage unit interface 310. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 300 to perform features or functions of the present application as discussed herein.

Various embodiments have been described with reference to specific exemplary features thereof. It will, however, be evident that various modifications and changes may be made thereto without departing from the broader spirit and scope of the various embodiments as set forth in the appended claims. The specification and figures are, accordingly, to be regarded in an illustrative rather than a restrictive sense.

Although described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the present application, whether or not such embodiments are described and whether or not such features are presented as being a part of a described embodiment. Thus, the breadth and scope of the present application should not be limited by any of the above-described exemplary embodiments.

Terms and phrases used in the present application, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A computer-implemented method, comprising:
receiving a first request from a communication platform, wherein the first request comprises a specific-user-content-based request, and wherein the specific-user-content-based request is indirectly generated by the user; and
initiating a classification process of the first request that generates an action attribute for the specific-user-content-based request;
initiating an extraction process of the first request that generates a parameter attribute for the action attribute of the specific-user-content-based request;
initiating a plurality of parameter functions based on the parameter attribute that generate at least one or more outputs; and
generating, using a large language model (LLM) or other machine learning model, a response to the first request using the action attribute generated by the classification process, the parameter attribute generated by the extraction process, and the one or more outputs generated by the plurality of parameter functions;
wherein the outputs generated by the plurality of parameter functions comprise generating at least a sentiment classification, semantically similar content, and a dynamically constructed prompt.

2. The computer-implemented method of claim 1, wherein the indirectly generated specific-user-content-based request comprises a request for home improvement vendor recommendations in a geographical location based on user's geographic location, user's preferences, and user's historic requests.

3. The computer-implemented method of claim 1, wherein the specific-user-content-based request is directly generated by the user.

4. The computer-implemented method of claim 3, wherein the directly generated specific-user-content-based request comprises a request from a user to join a location-based chat group.

5. The computer-implemented method of claim 1, further comprising:
receiving a second request from the communication platform, wherein the second request comprises a non-specific-user-content-based request.

6. The computer-implemented method of claim 5, wherein the non-specific-user-content-based request comprises a plurality of live user inputs from a plurality of users in a location-based chat group of the communication platform.

7. The computer-implemented method of claim 6, further comprising:
generating, using a large language model (LLM) or other machine learning model, a second response to each live user input in a location-based chat group of the communication platform of the second request using the action attribute generated by the classification process, the parameter attribute generated by the extraction process, and the one or more outputs generated by the plurality of parameter functions.

8. The computer-implemented method of claim 7, wherein the outputs generated by the plurality of parameter functions for each live user input in a location-based chat group of the communication platform of the second request comprise generating a sentiment classification and a semantically similar content to identify individual live user input in violation of a set of rules.

9. The computer-implemented method of claim 8, wherein the second response comprises removal of individual live user input from the location-based chat group identified in violation of the set of rules.

10. The method of claim 1, further comprising logging procedural function execution in an audit log for compliance verification.

11. The method of claim 1, wherein generating the response further comprises masking personally identifying information from the request before transmitting the response.

12. The method of claim 1, wherein initiating the classification or extraction process further comprises verifying a geolocation of the client device using at least GPS, Wi-Fi triangulation, or device fingerprinting.

13. A system comprising:
one or more computing processors; and
a machine-readable storage medium storing instructions that, when executed by the one or more processors, cause the system to:
receive a first request from a communication platform, wherein the first request comprises a specific-user-content-based request, and wherein the specific-user-content-based request is indirectly generated by the user;
initiate a classification process of the first request that generates an action attribute for the specific-user-content-based request;
initiate an extraction process of the first request that generates a parameter attribute for the action attribute of the specific-user-content-based request;
initiate a plurality of parameter functions based on the parameter attribute that generate at least one or more outputs; and
generate, using a large language model (LLM) or other machine learning model, a response to the first request using the action attribute generated by the classification process, the parameter attribute generated by the extraction process, and the one or more outputs generated by the plurality of parameter functions;
wherein the outputs generated by the plurality of parameter functions comprise at least a sentiment classification, a semantically similar content, and a dynamically constructed prompt.

14. The computer system of claim 13, wherein the indirectly generated specific-user-content-based request comprises a request for home improvement vendor recommendations in a geographical location based on user's geographic location, user's preferences, and user's historic requests.

15. The computer system of claim 13, wherein the specific-user-content-based request is directly generated by the user.

16. The computer system of claim 15, wherein the directly generated specific-user-content-based request comprises a request from a user to join a location-based chat group.

17. The computer system of claim 13, further comprising instructions to:
receive a second request from the communication platform, wherein the second request comprises a non-specific-user-content-based request.

18. The computer system of claim 17, wherein the non-specific-user-content-based request comprises a plurality of live user inputs from a plurality of users in a location-based chat group of the communication platform.

19. The computer system of claim 18, further comprising instructions to:
generate, using a large language model (LLM) or other machine learning model, a second response to each live user input in a location-based chat group of the communication platform of the second request using the action attribute generated by the classification process, the parameter attribute generated by the extraction process, and the one or more outputs generated by the plurality of parameter functions.

20. The computer system of claim 19, wherein the outputs generated by the plurality of parameter functions for each live user input in a location-based chat group of the communication platform of the second request comprise generating a sentiment classification and a semantically similar content to identify individual live user input in violation of a set of rules.

21. The computer system of claim 20, wherein the second response comprises removal of individual live user input from the location-based chat group identified violating the set of rules.
